(19) United States
(12) Patent Application Publication
(10) Pub. No.: US 2005/0250008 A1
(43) Pub. Date: Nov. 10, 2005

(54) Negative electrode material, process for producing the same and cell

(76) Inventors: Satoshi Mizutani, Fukushima (JP); Hiroshi Inoue, Fukushima (JP); Akinori Kita, Fukushima (JP); Takatomo Nishino, Fukushima (JP); Hiroaki Tanizaki, Miyagi (JP)

Correspondence Address: BELL, BOYD & LLOYD, LLC, P. O. BOX 1135, CHICAGO, IL, 60690-1135, US

(21) Appl. No.: 10/520,915

(22) PCT Filed: May 7, 2004
(86) PCT No.: PCT/JP04/06477

§ 371 Date: Jan. 7, 2005

(51) Int. Cl. H01M 4/02

(52) U.S. Cl. 429/209

(57) ABSTRACT

An anode material capable of providing a high capacity and improving cycle characteristics and a manufacturing method thereof, and a battery are provided. The anode material has a reaction phase containing an element capable of generating an intermetallic compound with Li and C. In this reaction phase, a half value width of a diffraction peak by X-ray diffraction is preferably 0.5° or more. Further, in this anode material, it is preferable that a peak of C is obtained in a region lower than 284.5 eV by XPS. In the case that Sn is contained as an element capable of generating an intermetallic compound with Li, it is preferable that an energy difference between a peak of 3d_{5/2} orbit of Sn and a peak of 1s orbit of C is larger than 200.1 eV. It becomes thereby possible that cohesion or crystallization of the element capable of generating an intermetallic compound with Li associated with charge and discharge can be inhibited.

### CROSS REFERENCES TO RELATED APPLICATIONS

The present application claims priority to Japanese Patent Document Nos. P2003-131231 filed on May 9, 2003, and P2003-403656 filed on Dec. 2, 2003, the disclosures of which are herein incorporated by reference.

### BACKGROUND OF THE INVENTION

The present invention relates to an anode material having a reaction phase containing, for example, an element capable of generating an intermetallic compound with lithium (Li) and carbon (C) and a manufacturing method thereof, and a battery.

In recent years, many portable electronic devices such as a combination camera (video tape recorder), a mobile phone, and a laptop personal computer have been introduced. Downsizing and weight saving of these devices have been made. Along with these situations, as a portable power source for these electronic devices, and as a key device as to batteries, particularly secondary batteries, research and development to improve the energy density has been actively promoted. Specially, a lithium ion secondary battery can provide a larger energy density compared to a lead battery or a nickel-cadmium battery. Therefore, improvement of the lithium secondary battery has been considered in respective fields.

For an anode material of the lithium ion secondary battery, conventionally, a carbonaceous material such as non-graphitizable carbon and graphite showing a relatively high capacity and having good cycle characteristics has been widely used. However, along with recent trend of high capacity, acquiring further high capacity of the anode material has been an issue to address.

To date, there has been a report that a high capacity is attained by an anode using a carbonaceous material obtained by selecting a carbonized material and fabrication conditions (refer to Japanese Unexamined Patent Application Publication No. H08-315825). However, since a discharge potential of the anode using the carbonaceous material is 0.8 V to 1.0 V with respect to lithium, a battery discharge voltage is low and major improvement in the energy density cannot be expected. Further, there are shortcomings that hysteresis is large in a charge and discharge curve shape, and energy efficiency in each charge and discharge cycle is low.

Meanwhile, as an anode material capable of realizing a high capacity over in the carbonaceous material, a material applying a fact that a certain kind of a metal is electrochemically alloyed with lithium, which is reversibly generated and decomposed has been widely researched. For example, Li—Al alloy has been widely researched, and Si alloy is reported in the specification of U.S. Pat. No. 4,950,566. However, these alloys are expanded and shrunk along with charge and discharge, and are pulverized every repetition of charge and discharge, and therefore, there is a problem that cycle characteristics of these alloys are extremely poor.

Therefore, in order to improve cycle characteristics, it has been considered that a surface of an alloy is covered with a material having high conductivity. For example, in Japanese Unexamined Patent Application Publication No. 2000-173669, Japanese Unexamined Patent Application Publication No. 2000-173670, and Japanese Unexamined Patent Application Publication No. 2001-68096, covering a surface of an alloy with a conductive material by dipping an alloy in an organic solvent in which a conductive material is dissolved, or by using mechanochemical reaction such as hybridization is considered.

However, in this case, improvement effects of the cycle characteristics are not sufficient as well, and actually, a capacity the alloy has is not fully utilized.

### SUMMARY OF THE INVENTION

The present invention relates to an anode material having a reaction phase containing, for example, an element capable of generating an intermetallic compound with lithium (Li) and carbon (C) and a manufacturing method thereof, and a battery.

In an embodiment, the invention provides an anode material capable of providing a high capacity and improving cycle characteristics and a manufacturing method thereof, and a battery.

A first anode material according to the invention in an embodiment is an anode material having a reaction phase containing: an element capable of generating an intermetallic compound with lithium; and carbon, wherein a peak of carbon is obtained in a region lower than 284.5 eV by X-ray photoelectron spectroscopy.

A second anode material according to the invention in an embodiment is an anode material having a reaction phase containing: tin (Sn); and carbon, wherein an energy difference between a peak of 3d_{5/2} orbit of tin atom (Sn3d_{5/2}) and a peak of 1s orbit of carbon atom (C1s) obtained by X-ray photoelectron spectroscopy is larger than 200.1 eV.

A method of manufacturing an anode material according to the invention in an embodiment is a method of manufacturing an anode material having a reaction phase containing an element capable of generating an intermetallic compound with lithium and carbon, including a step of synthesizing the anode material by mechanical alloying method by using a raw material containing an element capable of generating an intermetallic compound with lithium and a raw material for carbon.

A first battery according to the invention in an embodiment is a battery comprising: a cathode; an anode; and an electrolyte, wherein the anode contains an anode material having a reaction phase containing an element capable of generating an intermetallic compound with lithium and carbon, and wherein the anode material provides a peak of carbon in a region lower than 284.5 eV by X-ray photoelectron spectroscopy.

A second battery of the invention in an embodiment is a battery comprising: a cathode; an anode; and an electrolyte, wherein the anode contains an anode material having a reaction phase containing tin and carbon, and wherein in the anode material, an energy difference between a peak of 3d_{5/2} orbit of tin atom (Sn3d_{5/2}) and a peak of 1s orbit of carbon atom (C1s), which are obtained by X-ray photoelectron spectroscopy is larger than 200.1 eV.

According to the first anode material of the invention in an embodiment, the peak of carbon is obtained in the region lower than 284.5 eV by X-ray photoelectron spectroscopy. Therefore, it is possible that cohesion or crystallization of the element capable of generating an intermetallic compound with lithium associated with charge and discharge can be inhibited.

According to the second anode material of the invention in an embodiment, the energy difference between the peak of 3d_{5/2} orbit of tin atom (Sn3d_{5/2}) and the peak of 1s orbit of carbon atom (C1s) obtained by X-ray photoelectron spectroscopy is larger than 200.1 eV. Therefore, it is possible that cohesion or crystallization of tin associated with charge and discharge can be inhibited.

According to the method of manufacturing an anode material of the invention in an embodiment, the anode material is synthesized by mechanical alloying method by using the raw material containing the element capable of generating an intermetallic compound with lithium and the raw material for carbon. Therefore, the first and the second anode materials of the invention can be easily manufactured.

According to the first or the second battery of the invention in an embodiment, the first or the second anode material of the invention is used. Therefore, a high capacity can be obtained, and charge and discharge efficiency and cycle characteristics can be improved.

Additional features and advantages of the present invention are described in, and will be apparent from, the following Detailed Description of the Invention and the figures.

### BRIEF DESCRIPTION OF THE FIGURES

FIG. 1 is a perspective view showing a construction example of a mechanical alloying device used for fabricating an anode material according to an embodiment of the invention.

FIG. 2 is a cross section showing a construction of a secondary battery using the anode material according to the embodiment of the invention.

FIG. 3 shows peaks obtained by X-ray photoelectron spectroscopy according to anode materials of Examples 1-22 to 1-42 of the invention.

FIG. 4 shows peaks obtained by X-ray photoelectron spectroscopy according to anode materials of Comparative examples 1-8 to 1-15.

FIG. 5 is a cross section showing a construction of a coin type battery fabricated in examples of the invention.

### DETAILED DESCRIPTION OF THE INVENTION

The present invention relates to an anode material having a reaction phase containing, for example, an element capable of generating an intermetallic compound with lithium (Li) and carbon (C) and a manufacturing method thereof, and a battery.

An embodiment of the invention will be described in detail hereinafter with reference to the drawings.

An anode material according to an embodiment of the invention has a reaction phase capable of reacting with lithium and the like, and functions as an anode active material. This reaction phase contains, for example, an element capable of generating an intermetallic compound with lithium (hereinafter referred to as lithium active element). The lithium active element preferably contains, for example, at least one from the group consisting of elements from Group 11 to Group 15 in the long period periodic table. Specially, the lithium active element preferably contains silicon, tin, or both thereof. Silicon and tin have a high reacting amount with lithium per unit weight.

Further, in this case, in addition to silicon or tin, it is preferable that at least one of constituent, such as nickel (Ni), copper (Cu), iron (Fe), cobalt (Co), manganese (Mn), indium (In), zinc (Zn), and silver (Ag), is contained. It is also preferable that at least one of zinc, indium, and silver; and at least one of nickel, copper, iron, cobalt, and manganese are contained. The reason thereof is that cycle characteristics may be lowered when only silicon or tin is contained. These metal elements can exist as a compound with silicon or tin, or can exist as a mixture.

The reaction phase also contains carbon. When carbon is contained, the reaction phase becomes low crystal or amorphous, lithium is smoothly inserted and extracted, and reactivity with an electrolyte is reduced. It is preferable that the reaction phase further contains at least one from the group consisting of elements from Group 4 to Group 6 in the long period periodic table. The reason thereof is that it becomes possible to effectively inhibit cohesion and crystallization of the lithium active element after cycles.

In the reaction phase, for example, it is preferable that a half value width of a diffraction peak obtained by X-ray diffraction in which CuKα-ray is used as specific X-ray and sweep rate is 1°/min is 0.5° or more where a diffraction angle is 2θ. When the half value width is under 0.5°, action of carbon may not be sufficiently demonstrated.

In particular, the half value width is more preferably 1° or more, and even more preferably 5° or more. Further, an average crystal particle diameter of the reaction phase is preferably 10 μm or less, more preferably 1 μm or less, and even more preferably 100 nm or less. The reason thereof is that the reaction phase can become lower crystal, and further, become amorphous, and the foregoing action of carbon can be sufficiently obtained.

A diffraction peak corresponding to the reaction phase in X-ray diffraction analysis can be easily identified by comparing an X-ray diffraction chart before and after electrochemical reaction between lithium and the reaction phase. Such a diffraction peak corresponds to a diffraction peak which changes after electrochemical reaction. The diffraction peak corresponding to the reaction phase is often shown where a diffraction angle 2θ is in the range from 30° to 60°. The average crystal particle diameter can be examined by observing a crystal structure of the anode material by a transmission electron microscope.

Carbon in the reaction phase exists among the lithium active element, and is preferably bonded with a metal element or a metalloid element contained in the reaction phase. The lithium active element becomes cohered or crystallized along with charge and discharge, which is thought to be a cause of deterioration of cycle characteristics. However, when carbon is bonded with a metal element or a metalloid element contained in the reaction phase, the cohesion or the crystallization of the lithium active element along with charge and discharge can be inhibited. Meanwhile, when carbon is not bonded with other element and only exists among the lithium active element, it is hard to inhibit cohesion or crystallization of the lithium active element along with charge and discharge.

As a measurement method for examining a bonding state of an element, there is X-ray Photoelectron Spectroscopy (XPS). More specifically, XPS is a method for examining an element composition in a region being several nm from a sample surface and a bonding state of element by irradiating the sample surface with soft X-ray (Al—Kα-ray or Mg—Kα-ray is used for commercially available devices) and measuring kinetic energy of photoelectrons popping out from the sample surface. Details thereof will be hereinafter described.

Bonded energy of inner shell orbital electrons of each element is changed in correlation with negative electric charge densities on an element in primary approximation. For example, assume that an electric charge density on a given carbon element A is decreased by interaction with an element which exists in the vicinity thereof. In this case, outer shell electrons such as 2p electron are decreased. Therefore, 1s electron of the carbon element A becomes more strongly bonded by a shell of the carbon element A. As above, when the electric charge density on the element is decreased, a peak is shifted to a side wherein bonded energy is higher. That is, a bonded energy value reflects an electron state (bonding state) of the element. For example, a peak position of graphite is shown in 284.5 eV in a device in which energy calibration is made so that a peak of 4f orbit of gold atom (Au4f) is obtained in 84.0 eV.

In the case that carbon is bonded with other element, when XPS is conducted to an anode material, a peak of carbon is obtained in the region lower than 284.5 eV. In this case, compared to an electric charge density of carbon in graphite, the electric charge density is increased by interaction with a neighboring element. Generally, it is known that only when other element exists in the vicinity of carbon and the electric charge density thereof is increased, that is, only when carbon forms a carbide with other element, a peak is shown in the range lower than 284.5 eV. For example, it is known that a peak of titanium carbide (TiC) is shown in 281.5 eV, a peak of barium carbide (Ba₂C) is shown in 283.5 eV, a peak of (CH₂)ₙ is shown in 284.8 eV, a peak of sodium carbonate (Na₂CO₃) is shown in 289.4 eV, and a peak of CF₂CF₂ is shown in 292.6 eV, respectively.

Further, when tin is contained as a lithium active element, an energy difference between a peak of 3d_{5/2} orbit of tin atom (Sn3d_{5/2}) and a peak of 1s orbit of carbon atom (C1s), which are obtained for an anode material by XPS is larger than 200.1 eV. The reason is as follows. It has been reported that as a peak position of Sn3d_{5/2} in the state of a metal, there are 484.92 eV and 484.87 eV (for example, refer to D. Briggs and M. P. Seah, “Auger and X-ray Photoelectron Spectroscopy;” and “Practical Surface Analysis,” Second edition, John Wiley & Sons, 1990). It is thinkable that a peak position of Sn3d_{5/2} in the state of an alloy would be the same as in the state of a metal. Meanwhile, as to 1s orbit of carbon atom (C1s), a peak position of graphite is 284.5 eV, and a peak position of surface contamination carbon is 284.8 eV. In the case that a substance wherein an alloy and graphite are simply mixed is measured, a distance between two peaks of Sn3d_{5/2} and C1s is 484.9 eV (peak position of metallic tin)−284.8 eV (peak position of graphite)=200.1 eV. Therefore, when carbon interacts with other element, the peak distance becomes larger than 200.1 eV.

That is, a peak position of carbon in the anode material obtained by XPS is preferably lower than 284.5 eV. Further, when tin is contained as a lithium active element, an energy difference between peaks of Sn3d_{5/2} and C1s obtained by XPS is preferably larger than 200.1 eV, and more preferably larger than 200.4 eV, and from 200.5 eV to 202.4 eV. In such range, cohesion or crystallization of the lithium active element can be significantly inhibited.

Before XPS measurement for the anode material is conducted, the anode material is fixed by using a pressure-sensitive adhesive double coated tape or an indium metal. After that, when a surface thereof is covered with the surface contamination carbon, the surface is preferably provided with slight sputtering by an argon ion gun equipped with an XPS device. Further, when the measurement-targeted anode material exists in an anode of a battery as described later, the battery is decomposed to take out the anode, and then the anode is cleaned with a volatile solvent such as dimethyl carbonate. A solvent having a low volatility and an electrolyte salt which exist on the surface of the anode can be thereby removed. It is desirable that this sampling is conducted under an inert atmosphere.

Further, in XPS measurement, the peak of C1s is used for correction of energy axis of spectrum. Generally, the surface contamination carbon exists on the surface of a substance, which is used as an energy reference. In this embodiment, for example, a peak position of the surface contamination carbon is set to 284.8 eV. By this XPS measurement, a waveform of the peak of C1s is obtained by a sum of a peak of the surface contamination carbon and a peak of carbon in the composition. Therefore, by analyzing this waveform, the peak of carbon in the composition can be obtained. In waveform analysis, a position of a main peak existing on the lowest bonded energy side is set to 284.8 eV. Further, a commercially available software can be used for the waveform analysis. When tin is contained, a peak of Sn3d_{5/2} can be used as an energy reference.. In this case, energy correction is conducted by setting a peak position to 484.9 eV.

Further, in this anode material, a ratio of carbon is preferably 2% by weight or more, and more preferably 5% by weight or more. When carbon is little, a sufficiently fine crystal structure might not be obtained. Further, a ratio of carbon is preferably 50% by weight or less, and more preferably 40% by weight or less, and even more preferably 25% by weight or less. When carbon is much, a sufficient capacity is hard to be obtained.

Further, a specific surface area of the anode material is preferably from 0.05 m²/g to 70 m²/g. When the specific surface area is small, the anode material does not contact with an electrolyte or the like sufficiently. Meanwhile, when the specific surface area is large, reactivity with an electrolyte or the like becomes large, and the electrolyte might be decomposed. The specific surface area can be obtained by BET (Brunauer Emmett Teller) method.

Further, a median size of the anode material is preferably 50 μm or less, more preferably 30 μm or less, even more preferably 20 μm or less, and most preferably 5 μm or less. Further, a median size of the anode material is preferably 100 nm or more. In such a range, local expansion of the electrode can be effectively inhibited. The median size can be measured, for example, by a laser diffraction type particle size distribution measuring device.

The foregoing anode material can be manufactured, for example, as follows.

First, raw materials for composition elements of the anode material are prepared. As a raw material for carbon, one or more carbonaceous materials such as non-graphitizable carbon, graphitizable carbon, graphite, pyrolytic carbons, coke, glassy carbons, organic high molecular weight compound fired body, activated carbon, and carbon black can be used. A shape of these carbonaceous materials can be any of fiber type, spherical type, granular type, and scale type.

As a raw material for component elements other than carbon, that is, a raw material containing a lithium active element, powders or a mass of a simple substance of each component element can be used. It is also possible that after the powders or the mass is mixed, the mixture is dissolved in an electric furnace, a high frequency guidance furnace, or an arc-melting furnace, and the resultant is solidified. Otherwise, it is possible to use an alloy in which two or more of the foregoing respective component elements are alloyed by various atomization methods such as gas atomization and water atomization, or various roll methods. However, using the alloy is preferable, since low crystallization can be easily achieved, and reaction time can be shortened. The alloy can be powders or a mass.

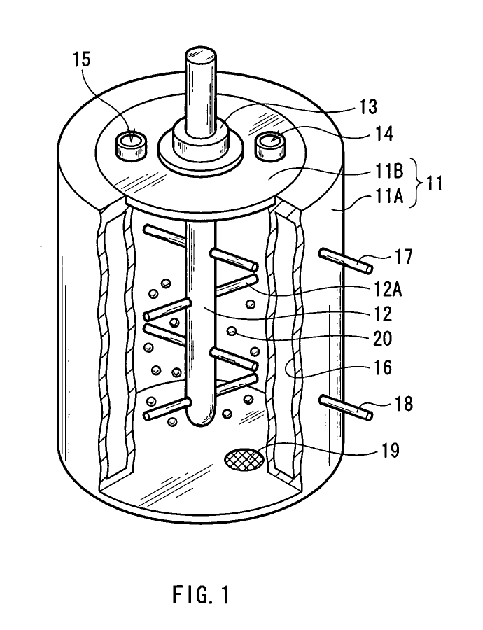

Next, mechanical alloying is conducted for these raw materials. For example, at least one of the lithium active elements and carbon are alloyed to synthesize the anode material. For this mechanical alloying, for example, a planet ball mill device and a device as shown in FIG. 1 can be used.

A media agitation type mechanical alloying device shown in FIG. 1 is used for fabricating alloy powders by alloying raw materials while pulverizing and mixing the raw materials by supplying a pulverizing tank 11 with the raw materials together with pulverizing balls 20 and inert gas (not shown), and agitating by a rotatable agitation shaft 12 provided with agitator arms 12A. The pulverizing tank 11 has a housing part 11A for housing the materials and the like and a lid 11B installed on top of the housing part 11A. The agitation shaft 12 is provided so that the agitation shaft 12 passes through the lid 11B through a gas seal 13. The lid 11B is provided with feed openings 14 and 15. The raw materials and the pulverizing balls 20 are supplied from the feed opening 14, and the inert gas is supplied from the feed opening 15 into the pulverizing tank 11, respectively. At a side wall of the housing part 11A, a jacket 16 in which a medium for heating or cooling inside of the pulverizing tank 11 to a desired temperature is circulating is provided. The medium circulating in the jacket 16 is supplied from a supply pipe 17 to the jacket 16, and is discharged from a discharging pipe 18 outside of the jacket 16. At the bottom of the housing part 11A, a discharging screen 19 is provided. By this discharging screen 19, fabricated alloy powders and the pulverizing balls 20 are separated, the pulverizing balls 20 remain inside the pulverizing tank 11, and only the alloy powders are discharged from the pulverizing tank 11.

Through the foregoing steps, the anode material of this embodiment is obtained.

This anode material is, for example, used for a battery as follows.

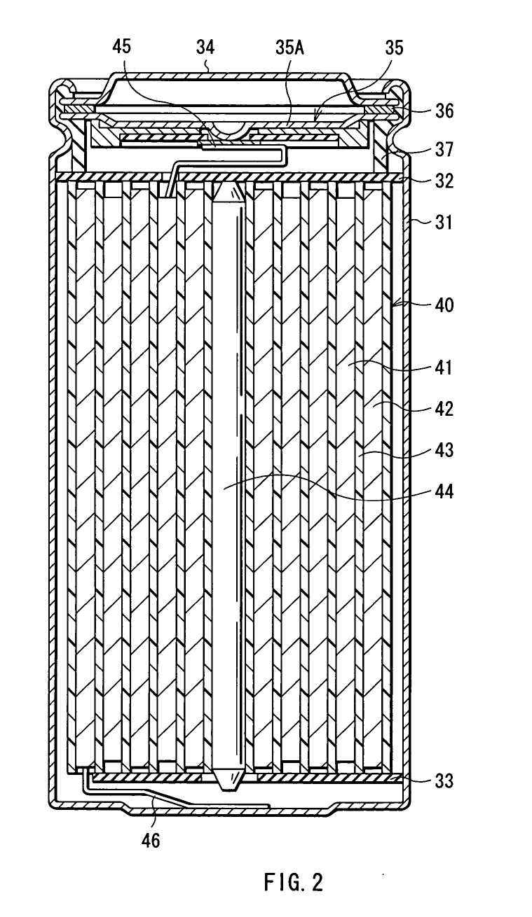

FIG. 2 shows a cross sectional structure of a secondary battery using the anode material according to the invention.

This secondary battery is a so-called cylinder-type battery, and has an winding electrode 40 in which a strip-shaped cathode 41 and a strip-shaped anode 42 are wound with a separator 43 in between inside a battery can 31 in the shape of an approximately hollow cylinder. The battery can 31 is made of, for example, iron plated by nickel. One end of the battery can 31 is closed, and the other end of the battery can 31 is opened. Inside the battery can 31, an electrolytic solution, a liquid electrolyte is injected, which is impregnated in the separator 43. A pair of insulating plates 32 and 33 are respectively arranged so that the winding electrode 40 is sandwiched between the insulating plates 32 and 33, and the insulating plates 32 and 33 are located perpendicular to the winding periphery face.

At the open end of the battery can 31, a battery cover 34, and a safety valve mechanism 35 and a PTC (Positive Temperature Coefficient) device 36 provided inside this battery cover 34 are installed by caulking through a gasket 37. Inside of the battery can 31 is sealed. The battery cover 34 is, for example, made of a material similar to that of the battery can 31. The safety valve mechanism 35 is electrically connected to the battery cover 34 through the PTC device 36. When an inner pressure of the battery becomes a certain level or more by inner short circuit or exterior heating, a disk plate 15A flips to cut the electrical connection between the battery cover 34 and the winding electrode 40. When a temperature is raised, the PTC device 36 limits a current by increasing its resistance value to prevent abnormal heat generation by a large current. The gasket 37 is made of, for example, an insulating material and a surface thereof is coated with asphalt.

The winding electrode 40 is wound, for example, centering on a center pin 44. A cathode lead 45 made of aluminum (Al) or the like is connected to the cathode 41 of the winding electrode 40. An anode lead 46 made of nickel or the like is connected to the anode 42. The cathode lead 45 is electrically connected to the battery cover 34 by being welded to the safety valve mechanism 35. The anode lead 46 is welded and electrically connected to the battery can 31.

The cathode 41 has, for example, though not shown, a structure in which a cathode mixture layer is provided on both sides or on a single side of the cathode current collector having a pair of facing faces. The cathode current collector is made of, for example, a metal foil such as an aluminum foil. The cathode mixture layer contains, for example, one or more cathode materials capable of inserting and extracting lithium as a cathode active material. The cathode mixture layer can also contain a conductive agent such as a carbon material and a binder such as polyvinylidene fluoride according to need.

As a cathode material capable of inserting and extracting lithium, for example, a metal sulfide or a metal oxide which does not contain lithium such as titanium sulfide (TiS₂), molybdenum sulfide (MoS₂), niobium selenide (NbSe₂), and vanadium oxide (V₂O₅) can be cited. Further, lithium complex oxides having a main body of LiₓMO₂ (in the formula, M represents one or more transition metals, and x varies according to charge and discharge states of the battery and generally in the range of 0.05≦x≦1.10) can be cited. As a transition metal M, a component of this lithium complex oxide, cobalt, nickel, manganese and the like are preferable. Concrete examples of such a lithium complex oxide include LiCoO₂, LiNiO₂, LiₓNi_{y}Co_{1-y}O₂ (in the formula, x and y vary according to charge and discharge states of the battery, and generally are in the range of 0<x<1 and 0.7<y<1.02), and lithium manganese complex oxides having a spinel type structure.

As the cathode 41 does, though not shown, the anode 42 has, for example, a structure in which anode mixture layer is provided on both sides or on a single side of an anode current collector having a pair of facing faces. The anode current collector is made of, for example, a metal foil such as a copper foil.

The anode mixture layer contains, for example, the anode material according to this embodiment, and is constructed with a binder such as polyvinylidene fluoride according to need. By containing the anode material according to this embodiment as above, in this secondary battery, a high capacity can be obtained, and charge and discharge efficiency and cycle characteristics can be improved. The anode mixture layer can contain other anode active material or other materials such as a conductive agent, in addition to the anode material according to this embodiment. As other anode active material, for example, a carbonaceous material capable of inserting and extracting lithium can be cited. This carbonaceous material is preferable since this carbonaceous material can improve charge and discharge cycle characteristics and functions as a conductive agent. Examples of the carbonaceous materials include pyrolytic carbons, coke, glassy carbons, organic high molecular weight compound fired body, activated carbon, and carbon blacks. Of the foregoing, examples of the cokes include pitch coke, needle coke, and petroleum coke. The organic high molecular weight compound fired body is obtained by firing and carbonizing at appropriate temperatures a high molecular weight compound such as a phenol resin and a furan resin. A shape of these carbonaceous materials can be any of fiber type, spherical type, granular type, and scale type.

A ratio of this carbonaceous material is preferably in the range from 1% by weight to 95% by weight with respect to the anode material according to this embodiment. When the carbonaceous material is little, conductivity of the anode 34 is lowered. Meanwhile, when the carbonaceous material is much, a battery capacity is lowered.

The separator 43 is intended to separate the cathode 41 from the anode 42, prevent current short circuit due to contact of the both electrodes, and let through lithium ions. This separator 43 is constructed of, for example, a porous film made of a synthetic resin such as polytetrafluoro ethylene, polypropylene, and polyethylene, or a porous film made of a ceramics. The separator 43 can have a structure in which two or more of the foregoing porous films are layered.

The electrolytic solution impregnated in the separator 43 contains a solvent and an electrolyte salt dissolved in this solvent. As a solvent, propylene carbonate, ethylene carbonate, diethyl carbonate, dimethyl carbonate, 1,2-dimethoxy ethane, 1,2-diethoxy ethane, γ-butyrolactone, tetrahydrofuran, 2-methyl tetrahydrofuran, 1,3-dioxolane, 4-methyl-1,3-dioxolane, diethyl ether, sulfolane, methyl sulfolane, acetonitrile, propionitrile, anisole, acetic ester, butyric ester, and ester propionate can be cited. As a solvent, any one of the foregoing can be singly used, or a mixture of two or more of the foregoing can be used.

As an electrolyte salt, for example, a lithium salt can be cited. One of lithium salts can be singly used, or a mixture of two or more of lithium salts can be used as an electrolyte salt. Examples of the lithium salts include LiClO₄, LiAsF₆, LiPF₆, LiBF₄, LiB(C₆H₅)₄, CH₃SO₃Li, CF₃SO₃Li, LiCl, and LiBr.

Instead of the electrolytic solution, a gelatinous electrolyte or a solid electrolyte can be used. The gelatinous electrolyte is, for example, an electrolyte in which an electrolytic solution is held in a high molecular weight compound. The electrolytic solution (that is, a solvent, an electrolyte salt and the like) is as described above. Any high molecular weight compound can be used as long as a high molecular weight compound can absorb and gelate an electrolytic solution. Examples of such a high molecular weight compound include fluorine high molecular weight compounds such as polyvinylidene fluoride and a copolymer of vinylidene fluoride and hexafluoro propylene; ether high molecular weight compounds such as polyethylene oxide and a cross-linking body containing polyethylene oxide; and polyacrylic nitrile. In particular, in view of redox stability, the fluorine high molecular weight compound is desirable.

As a solid electrolyte, for example, any of inorganic solid electrolytes and high molecular weight solid electrolytes can be used, as long as a solid electrolyte is a material having lithium ion conductivity. Examples of the inorganic solid electrolyte include inorganic solid electrolyte containing lithium nitride or lithium iodide. The high molecular weight solid electrolyte is mainly constructed of an electrolyte salt and a high molecular weight compound for dissolving the electrolyte salt. As a high molecular weight compound of the high molecular weight solid electrolyte, for example, an ether high molecular weight compound such as polyethylene oxide and a cross-linking body containing polyethylene oxide, an ester high molecular weight compound such as polymethacrylate, and an acrylate high molecular weight compound can be used singly or by mixing or copolymerizing them. When such a solid electrolyte is used, the separator 35 can be removed.

In this secondary battery, when charged, for example, lithium ions are extracted from the cathode 41, and are inserted in the anode 42 through the electrolyte. When discharged, for example, lithium ions are extracted from the anode 42, and are inserted in the cathode 41 through the electrolyte. Here, the anode 42 contains an anode material, wherein at least one of the lithium active elements and carbon are contained and carbon is bonded with a metal element or a metalloid element. Therefore, lithium is smoothly inserted and extracted, and reaction with an electrolyte is inhibited. Further, good contact characteristics and reactivity with respect to the electrolyte are secured. Furthermore, cohesion or crystallization of the lithium active element associated with charge and discharge can be inhibited.

This secondary battery can be manufactured, for example, as follows.

First, for example, a cathode material, and if necessary, a conductive agent and a binder are mixed to prepare a cathode mixture. This cathode mixture is dispersed in a mixture solvent such as N-methyl pyrrolidone to form a cathode mixture slurry. Next, the cathode current collector is coated with this cathode mixture slurry, dried, and compressed to form the cathode mixture layer. In the result, the cathode 41 is fabricated. Subsequently, the cathode lead 45 is welded to the cathode 41.

Further, for example, an anode material according to this embodiment, and if necessary, a binder are mixed to prepare an anode mixture. This anode mixture is dispersed in a mixture solvent such as N-methyl pyrrolidone to form an anode mixture slurry. Next, the anode current collector is coated with this anode mixture slurry, dried, and compressed to form the anode mixture layer. In the result, the anode 42 is fabricated. Subsequently, the anode lead 46 is welded to the anode 42.

Subsequently, the cathode 41 and the anode 42 are wound with the separator 43 in between. An end of the cathode lead 45 is welded to the safety valve mechanism 35, and an end of the anode lead 46 is welded to the battery can 31. The wound cathode 41 and anode 42 are sandwiched between the pair of insulating plates 32 and 33, and the cathode 41 and the anode 42 are thereby housed inside the battery can 31. Next, an electrolytic solution is injected inside the battery can 31. After that, at the open end of the battery can 31, the battery cover 34, the safety valve mechanism 35, and the PTC device 36 are fixed by caulking through the gasket 37. The secondary battery shown in FIG. 2 is thereby completed.

As described above, according to the anode material of this embodiment, a peak of carbon can be obtained in the region lower than 284.5 eV by XPS. Therefore, cohesion or crystallization of the lithium active element associated with charge and discharge can be inhibited.

Further, when tin is contained, an energy difference between a peak of Sn3d_{5/2} and a peak of C1s, which are obtained by XPS is larger than 200.1 eV. Therefore, cohesion or crystallization of tin associated with charge and discharge can be inhibited.

Therefore, according to the battery of this embodiment, since the anode material of the invention is used, a high capacity can be obtained, and charge and discharge efficiency and cycle characteristics can be improved.

Further, according to the method of manufacturing an anode material according to this embodiment, at least one of the lithium active elements and carbon are alloyed by mechanical alloying method. Therefore, the anode material according to this embodiment can be easily manufactured.

The anode material according to this embodiment can be manufactured by a method other than mechanical alloying method, for example, a melting method such as atomization method and roll method.

Further, descriptions will be hereinafter given of concrete examples of the invention.

### Confirmation Experiment of Effects of Adding Carbon: Examples 1-1 to 1-42

As Examples 1-1 to 1-21, the anode materials described in the embodiment whose specific surface area and median size were the values shown in Table 1-1 to Table 1-4 were fabricated. Then, the kinds and the ratios of component elements other than carbon and the ratio of carbon in the anode material were changed in Examples 1-1 to 1-21 as shown in Table 1-1 to Table 1-4. The bar (−) in the crystal particle diameter column in Tables 1-6 and 1-7 represents that confirmation was not allowed since the crystal particle diameter was too small. Further, as Comparative examples 1-1 to 1-7 with respect to Examples 1-1 to 1-21, anode materials were fabricated as in Examples 1-1 to 1-21, except that the composition, the specific surface area, and the median size were changed as shown in Table 1-5. Further, as Examples 1-22 to 1-42, the anode materials described in the embodiment whose specific surface area, crystal particle diameter in the reaction phase, and median size were the values shown in Table 1-6 or Table 1-7 were fabricated. Then, the kinds and the ratios of component elements other than carbon and the ratio of carbon in the anode material were changed as shown in Table 1-6 or Table 1-7. In addition, as Comparative examples 1-8 to 1-15 with respect to Examples 1-22 to 1-42, anode materials were fabricated as in Examples 1-22 to 1-42, except that the composition, the specific surface area, the crystal particle diameter of the reaction phase, and the median size were changed as shown in Table 1-8. More specifically, first, alloy powders in which other component elements are alloyed as a raw material for other component elements other than carbon and graphite powders as a raw material for carbon were injected into the media agitation type mechanical alloying device (Mitsui Mining Co., Ltd. make) shown in FIG. 1 so that the sum thereof became 1 kg. Next, after about 18 kg of hard chromium balls as pulverizing balls 20, being about 9 mm in diameter were further injected, the inside of the pulverizing tank 11 was substituted with argon, inert gas. Subsequently, the agitation shaft 12 was operated for 10 hours at a rotational rate of 250 rpm, and then stopped for 10 minutes. This operation was repeated until the sum of the operation time became 20 hours. Subsequently, after the pulverizing tank 11 was cooled down to the room temperature, synthesized powders were taken out from the pulverizing tank 11, and coarse powders were removed by a screen having a mesh count of 200. The anode materials of Examples 1-1 to 1-42 and Comparative examples 1-1 to 1-15 were thereby obtained. Regarding the anode materials of Examples 1-1 to 1-42 and Comparative examples 1-1 to 1-8, the X-ray diffraction pattern was measured by X-ray diffraction analysis, and the half value width of the peak corresponding to the reaction phase was examined. As an X-ray diffraction device, RAD-IIC, Rigaku make was used. In the measurement, CuKα-ray was used as specific X-ray and sweep rate was 1°/min. The obtained results are shown in Table 1-1 to Table 1-8.

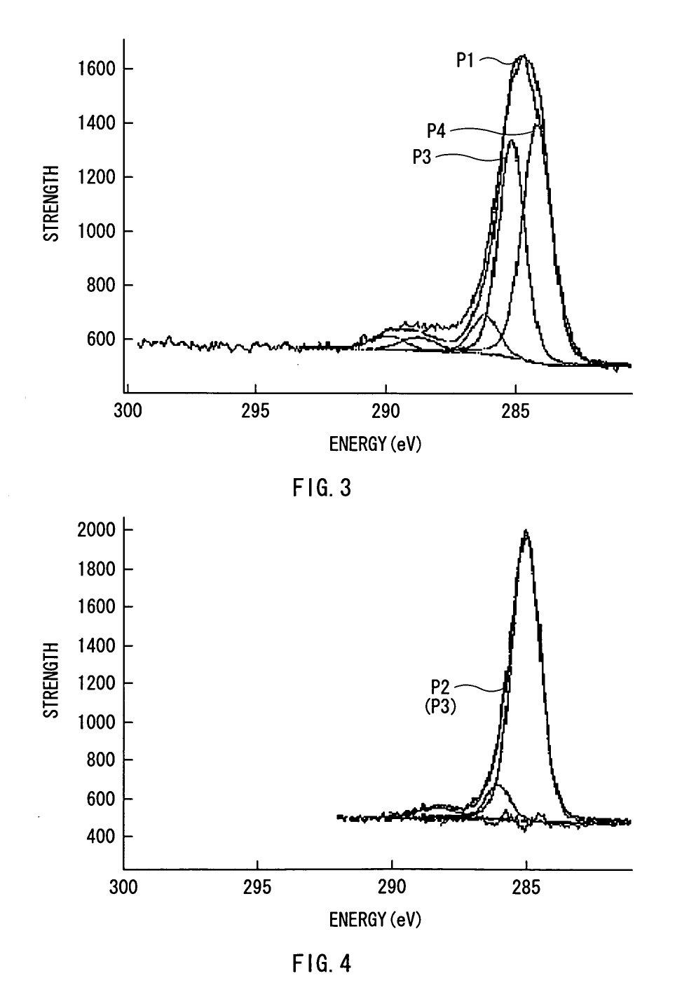

Further, regarding the anode materials of Examples 1-22 to 1-42 and Comparative examples 1-8 to 1-15, XPS was conducted. In the result, in Examples 1-22 to 1-42, peak P1 as shown in FIG. 3 was obtained, and in Comparative examples 1-8 to 1-15, peak P2 as shown in FIG. 4 was obtained. Further, when the obtained peaks P1 and P2 were analyzed, in Examples 1-22 to 1-42, peak P3 of surface contamination carbon and peak P4 of C1s in the anode material composition on the energy side lower than of the peak P3 were obtained as shown in FIG. 3. Meanwhile, in Comparative examples 1-8 to 1-15, as shown in FIG. 4, only peak P3 of surface contamination carbon was obtained. In Table 1-6 to Table 1-8, the energy value of the peak of C1s in the anode material composition obtained by XPS, and the energy difference between the peak of Sn3d_{5/2} and the peak of C1s are shown.

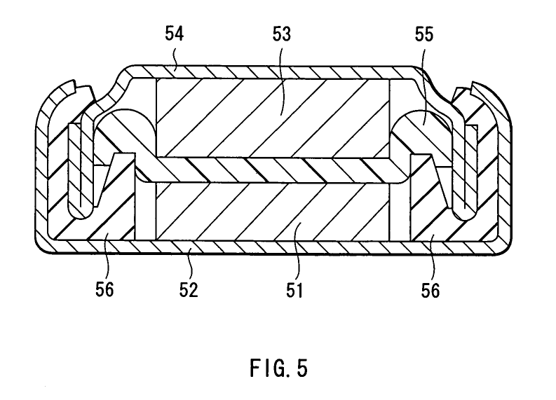

Further, coin type batteries as shown in FIG. 5 were fabricated by using the anode materials of Examples 1-1 to 1-42 and Comparative examples 1-1 to 1-15, the charge and discharge characteristics were evaluated, and the cycle characteristics of the anode materials were examined. In this coin type battery, a test electrode 51 using the anode material of these examples is housed in an exterior member 52, a counter electrode 53 made of metallic lithium was attached to an exterior member 54, these electrodes were layered with a separator 55 in which an electrolytic solution was impregnated in between, and then the layered body was provided with caulking through gaskets 56.

The test electrode 51 was fabricated as follows. First, 46% by weight of the obtained anode material, 46% by weight of graphite, which was a conductive agent and an anode material, 2% by weight of acetylene black as a conductive agent, and 6% by weight of polyvinylidene fluoride as a binder were mixed, the mixture was dispersed in N-methyl pyrrolidone, a mixture solvent to form a slurry. Next, a copper foil was coated with this slurry, dried, and compression-molded under a constant pressure. The resultant was punched out into a pellet being 15.2 mm in diameter. A metallic lithium plate punched out into size being 15.5 mm in diameter was used for the counter electrode 53. As an electrolytic solution, a solution in which LiPF₆ as an electrolyte salt was dissolved into a mixture solvent of ethylene carbonate, propylene carbonate, and dimethyl carbonate was used. The size of the coin type battery was about 20 mm in diameter and about 1.6 mm in thickness.

Charge and discharge were conducted as follows. Here, the charge is reaction of lithium insertion into the alloy material, and the discharge means reaction of extracting lithium. First, after constant current charge was conducted at 1 mA of a constant current until a voltage reached 5 mV, constant voltage charge was conducted until a current reached 50 μA. Next, a constant current was conducted at 1 mA of a constant current until a voltage reached 1.2 V. Cycle characteristics were evaluated as a capacity retention ratio at the 40th cycle with respect to the first cycle. The results are shown in Table 1-1 to Table 1-8.

As shown in Table 1-1 to Table 1-8, according to Examples 1-1 to 1-42, the higher capacity retention ratio could be obtained compared to in Comparative examples 1-1 to 1-15. That is, it was found that when the reaction phase contained carbon in addition to the lithium active element, cycle characteristics could be improved.

### Discussion about Half Value Width: Examples 2-1 to 2-3

As Examples 2-1 to 2-3 and Comparative example 2-1 thereto, anode materials were fabricated as in Example 1 - 1, except that the composition, the specific surface area, and the median size were changed as shown in Table 2. Regarding the anode materials of Examples 2-1 to 2-3 and Comparative example 2-1, the half value width of the peak corresponding to the reaction phase was also obtained as in Example 1-1. Further, coin type batteries were fabricated as in Example 1-1 by using the anode materials of Examples 2-1 to 2-3 and Comparative example 2-1, and respective capacity retention ratios at the 40th cycle were obtained. The results are shown in Table 2 with the result of Example 1-1. As shown in Table 2, the significantly high capacity retention rates were obtained where the half value width of the peak corresponding to the reaction phase was 0.5° or more. That is, it was found that the half value width of the peak corresponding to the reaction phase was preferably 0.5° or more.

### Discussion about Specific Surface Area: Example 3-1

As Example 3-1 and Comparative examples 3-1 and 3-2 thereto, anode materials were fabricated as in Example 1-1, except that the composition, the specific surface area, and the median size were changed as shown in Table 3. Regarding the anode materials of Example 3-1 and Comparative examples 3-1 and 3-2, the half value width of the peak corresponding to the reaction phase was also obtained as in Example 1-1. Further, coin type batteries were fabricated as in Example 1-1 by using the anode materials of Example 3-1 and Comparative examples 3-1 and 3-2, and respective capacity retention ratios at the 40th cycle were obtained. The obtained results are shown in Table 3 with the result of Example 1-1. As shown in Table 3, the trend was shown that the capacity retention ratio was improved when the specific surface area of the anode material became large, but after the maximum value was shown, the capacity retention ratio was lowered. That is, it was found that when the specific surface area of the anode material was from 0.05 m²/g to 70 m²/g, the cycle characteristics could be further improved.

### Discussion about C1s Peak and Sn3d_{5/2} Peak-C1s Peak: Examples 4-1 to 4-4

As Examples 4-1 to 4-4 and Comparative example 4-1 thereto, anode materials were fabricated as in Example 1-22, except that the composition, the specific surface area, the crystal particle diameter of the reaction phase, and the median size were changed as shown in Table 4. The bar (−) in the crystal particle diameter of the reaction phase column represents that confirmation was not allowed since the crystal particle diameter was too small. Regarding the anode materials of Examples 4-1 to 4-4 and Comparative example 4-1, the half value width of the peak corresponding to the reaction phase was also obtained as in Example 1-22. Further, XPS was conducted as in Example 1-22, and the peak thereby obtained was analyzed. Further, coin type batteries were fabricated as in Example 1-1 by using the anode materials of Examples 4-1 to 4-4 and Comparative example 4-1, and respective capacity retention ratios at the 40th cycle were obtained. The results are shown in Table 4-1 or Table 4-2 with the results of Comparative examples 1-9 and 1-10. As shown in Table 4-2, though containing carbon, Comparative example 4-1 showed the low capacity retention ratio. Further, as shown in Table 4-1, when the energy value of Cls peak was lower than 284.5 eV, or the energy difference between Sn3d_{5/2} peak and C1s peak was larger than 200.1 eV, the significantly high capacity retention ratios were obtained. That is, it was found that by setting the energy value of C1s peak to a lower value than 284.5 eV, or setting the energy difference between Sn3d_{5/2} peak and C1s peak to a larger value than 200.1 eV, cycle characteristics could be significantly improved.

### Discussion about Crystal Particle Diameter of Reaction Phase: Examples 5-1 to 5-10

As Examples 5-1 to 5-10, anode materials were fabricated as in Example 1-22, except that the composition, the specific surface area, the crystal particle diameter of the reaction phase, and the median size were changed as shown in Table 5-1 or Table 5-2. Regarding the anode materials of Examples 5-1 to 5-10, the half value width of the peak corresponding to the reaction phase was also obtained as in Example 1-1. Further, XPS was conducted as in Example 1-22. Further, coin type batteries were fabricated as in Example 1-22 by using the anode materials of Examples 5-1 to 5-10, and respective capacity retention ratios at the 40th cycle were obtained. The results are shown in Table 5-1 or Table 5-2 with the result of Example 1-23. As shown in Table 5-1 or Table 5-2, the trend was shown that the capacity retention ratio was improved when the average crystal particle diameter of the reaction phase became small. That is, it was found that the average crystal particle diameter of the reaction phase was preferably 10 μm or less, more preferably 1 μm or less, and even more preferably 100 nm or less.

### Discussion about Ratio of Carbon: Examples 6-1 to 6-17

As Examples 6-1 to 6-6, anode materials were fabricated as in Example 1-1, except that the composition, the specific surface area, and the median size were changed as shown in Table 6-1. Further, as Examples 6-7 to 6-17, anode materials were fabricated as in Example 1-22, except that the composition, the specific surface area, the crystal particle diameter of the reaction phase, and the median size were changed as shown in Table 6-2 or Table 6-3. The bar (−) in the crystal particle diameter column in Tables 6-2 and 6-3 represents that confirmation was not allowed since the crystal particle diameter was too small. Regarding the anode materials of Example 6-1 to 6-17, the half value width of the peak corresponding to the reaction phase was also obtained as in Examples 1-1 and 1-22. Further, regarding the anode materials of Examples 6-7 to 6-17, XPS was conducted as in Example 1-22, and the peak thereby obtained was analyzed. Further, coin type batteries were fabricated as in Example 1-1 and Example 1-22 by using the anode materials of Examples 6-1 to 6-17, and respective capacity retention ratios at the 40th cycle were obtained. The obtained results are shown in Tables 6-1 to 6-3 with the results of Examples 1-1, 1-23, and 1-32, and Comparative examples 1-1 and 1-9. As shown in Tables 6-1 to 6-3, the trend was shown that the capacity retention ratio was improved when the ratio of carbon became large, but after the maximum value was shown, the capacity retention ratio was lowered. That is, it was found that the ratio of carbon in the anode material was preferably 2% by weight or more, and more preferably 5% by weight or more. Further it was also found that the ratio of carbon in the anode material was preferably 50% by weight or less, more preferably 40% by weight or less, and even more preferably 25% by weight or less.

### Discussion about Median Size: Examples 7-1 to 7-11

As Examples 7-1 to 7-5, anode materials were fabricated as in Example 1-1, except that the composition, the specific surface area, and the median size were changed as shown in Table 7-1. Further, as Examples 7-6 to 7-11, anode materials were fabricated as in Example 1-22, except that the composition, the specific surface area, the crystal particle diameter of the reaction phase, and the median size were changed as shown in Table 7-2 or Table 7-3. The bar (−) in the crystal particle diameter column in tables 7-2 and 7-3 represents that confirmation was not allowed since the crystal particle diameter was too small. Regarding the anode materials of Example 7-1 to 7-11, the half value width of the peak corresponding to the reaction phase was also obtained as in Examples 1-1 and 1-22. Further, regarding the anode materials of Examples 7-6 to 7-11, XPS was conducted as in Example 1-22. Further, coin type batteries were fabricated as in Example 1-1 by using the anode materials of Examples 7-1 to 7-11, and respective capacity retention ratios at the 40th cycle were obtained. The obtained results are shown in Tables 7-1 to 7-3 with the results of Examples 1-23 and 1-32. As shown in Tables 7-1 to 7-3, the trend was shown that the capacity retention ratio was improved when the median size became large, but after the maximum value was shown, the capacity retention ratio was lowered. That is, it was found that the median size of the anode material was preferably 50 μm or less, more preferably 30 μm or less, even more preferably 20 μm or less, and most preferably 5 μm or less.

### Discussion about Manufacturing Method: Examples 8-1 to 8-6

As Examples 8-1 and 8-2, anode materials described in the embodiment whose specific surface area and median size are the values shown in Table 8-1 were fabricated by atomization method, by using respective powders of other component elements as a raw material for component elements other than carbon and graphite powders as a raw material for carbon. Then, the kinds and the ratios of the component elements other than carbon and the ratio of carbon in the anode material were changed in Examples 8-1 and 8-2 as shown in Table 8-1. Further, as Comparative examples 8-1 and 8-2 with respect to Examples 8-1 and 8-2, anode materials were fabricated as in Examples 8-1 and 8-2, except that the composition, the specific surface area, and the median size were changed as shown in Table 8-1. Further, as Examples 8-3 and 8-4, anode materials were fabricated as in Example 1-22, except that respective powders of other component elements were used as a raw material for component elements other than carbon and graphite powders were used as a raw material for carbon, and the composition, the specific surface area, and the median size were changed as shown in Table 8-2. The bar (−) in the crystal particle diameter column in Table 8-2 represents that confirmation was not allowed since the crystal particle diameter was too small. In addition, as Comparative examples 8-3 and 8-4 with respect to Examples 8-3 and 8-4, anode materials were fabricated as in Examples 8-3 and 8-4, except that the composition, the specific surface area, and the median size were changed as shown in Table 8-2. Further, as Examples 8-5 and 8-6, the anode materials described in the embodiment whose specific surface area, crystal particle diameter of the reaction phase, and median size were the values shown in Table 8-3 were fabricated by atomization method, by using alloy powders in which other component elements were alloyed as a raw material for component elements other than carbon and graphite powders as a raw material for carbon. Then, the kinds and the ratios of the component elements other than carbon and the ratio of carbon in the anode material were changed in Examples 8-5 and 8-6 as shown in Table 8-3.

Regarding the anode materials of Examples 8-1 to 8-6, the half value width of the peak corresponding to the reaction phase was obtained as in Example 1-1. Further, regarding the anode materials of Examples 8-3 to 8-6, XPS was conducted as in Example 1-22, and the peak thereby obtained was analyzed. Further, coin type batteries were fabricated by using the anode materials of Examples 8-1 to 8-6 as in Examples 1-1 and 1-22, and the capacity retention ratio at the 40th cycle was obtained. The results thereof are shown in Table 8-1 to Table 8-3. As shown in Table 8-1 to Table 8-3, according to Examples 8-1 to 8-6, the higher capacity retention ratio could be obtained compared to in corresponding Comparative examples 8-1 to 8-4. That is, it was found that even when respective powders of other component elements were used as a raw material for component elements other than carbon, or even when the raw materials were alloyed by atomization, cycle characteristics could be improved as long as carbon was contained in addition to the lithium active element.

While the invention has been described with reference to the embodiment and examples, the invention is not limited to the foregoing embodiment and examples, and various modifications may be made. For example, in the foregoing embodiment, the invention has been described by taking a concrete example of the cylindrical type secondary battery. However, a shape of the battery of the invention is not particularly limited. For example, the shape of the battery can be square type, coin type, button type, and the like. Further the battery size is optional, and the invention can be applied to a large battery for electric vehicles. Further, in the foregoing embodiment and Examples, descriptions have been given of the secondary batteries, but the invention can be similarly applied to other batteries such as primary batteries.

TABLE 1-1

| | Composition | | | | | | Capac- |
|---|---|---|---|---|---|---|---|
| | Component | | | | | | ity |
| | element other | | | Specific | Me- | Half | reten- |
| | than C | | Ratio | surface | dian | value | tion |
| | | Ratio | of C | area | size | width | ratio |
| | Kind | (wt %) | (wt %) | (m²/g) | (μm) | (°) | (%) |
| Example 1-1 | Co | 39.8 | 0.5 | 2.0 | 2 | 5 | 72 |
| | Sn | 59.7 | | | | | |
| Example 1-2 | Zn | 33.6 | 20 | 2.0 | 2 | 5 | 88 |
| | Sn | 46.4 | | | | | |
| Example 1-3 | Fe | 25.6 | 20 | 2.0 | 2 | 5 | 87 |
| | Sn | 54.4 | | | | | |
| Example 1-4 | Cu | 36 | 20 | 2.0 | 2 | 5 | 89 |
| | Sn | 44 | | | | | |
| Example 1-5 | Ni | 25.6 | 20 | 2.0 | 2 | 5 | 91 |
| | Sn | 54.4 | | | | | |
| Example 1-6 | Mn | 24 | 20 | 2.0 | 2 | 5 | 88 |
| | Sn | 56 | | | | | |
| Example 1-7 | Ag | 33.6 | 20 | 2.0 | 2 | 5 | 89 |
| | Sn | 46.4 | | | | | |

TABLE 1-2

| | Composition | | | | | | Capac- |
|---|---|---|---|---|---|---|---|
| | Component | | | | | | ity |
| | element other | | | Specific | Me- | Half | reten- |
| | than C | | Ratio | surface | dian | value | tion |
| | | Ratio | of C | area | size | width | ratio |
| | Kind | (wt %) | (wt %) | (m²/g) | (μm) | (°) | (%) |
| Example 1-8 | Co | 32 | 20 | 2.0 | 2 | 5 | 91 |
| | Sn | 46.4 | | | | | |
| | Ge | 1.6 | | | | | |
| Example 1-9 | Co | 32 | 20 | 2.0 | 2 | 5 | 91 |
| | Sn | 46.4 | | | | | |
| | Bi | 1.6 | | | | | |
| Example | Co | 32 | 20 | 2.0 | 2 | 5 | 92 |
| 1-10 | Sn | 46.4 | | | | | |
| | Sb | 1.6 | | | | | |
| Example | Co | 32 | 20 | 2.0 | 2 | 5 | 91 |
| 1-11 | Sn | 46.4 | | | | | |
| | Zn | 1.6 | | | | | |
| Example | Co | 32 | 20 | 2.0 | 2 | 5 | 91 |
| 1-12 | Sn | 46.4 | | | | | |
| | Fe | 1.6 | | | | | |
| Example | Co | 32 | 20 | 2.0 | 2 | 5 | 89 |
| 1-13 | Sn | 46.4 | | | | | |
| | Cu | 1.6 | | | | | |
| Example | Co | 32 | 20 | 2.0 | 2 | 5 | 89 |
| 1-14 | Sn | 46.4 | | | | | |
| | Ni | 1.6 | | | | | |
| Example | Co | 32 | 20 | 2.0 | 2 | 5 | 89 |
| 1-15 | Sn | 46.4 | | | | | |
| | Cr | 1.6 | | | | | |

TABLE 1-3

| | Composition | | | | | | Capac- |
|---|---|---|---|---|---|---|---|
| | Component | | | | | | ity |
| | element other | | | Specific | | Half | reten- |
| | than C | | Ratio | surface | Median | value | tion |
| | | Ratio | of C | area | size | width | ratio |
| | Kind | (wt %) | (wt %) | (m²/g) | (μm) | (°) | (%) |
| Example | Co | 30.26 | 11 | 2.0 | 2 | 5 | 92 |
| 1-16 | Sn | 53.4 | | | | | |
| | In | 5.34 | | | | | |
| Example | Co | 30.26 | 11 | 2.0 | 2 | 5 | 93 |
| 1-17 | Sn | 53.4 | | | | | |
| | Ag | 5.34 | | | | | |
| Example | Co | 30.26 | 11 | 2.0 | 2 | 5 | 91 |
| 1-18 | Sn | 53.4 | | | | | |
| | Zn | 5.34 | | | | | |
| Example | Co | 30.26 | 11 | 2.0 | 2 | 5 | 91 |
| 1-19 | Sn | 53.4 | | | | | |
| | In | 5.34 | | | | | |

TABLE 1-4

| | Composition | | | | | | Capac- |
|---|---|---|---|---|---|---|---|
| | Component | | | | | | ity |
| | element other | | | Specific | | Half | reten- |
| | than C | | Ratio | surface | Median | value | tion |
| | | Ratio | of C | area | size | width | ratio |
| | Kind | (wt %) | (wt %) | (m²/g) | (μm) | (°) | (%) |
| Example | Co | 28.48 | 11 | 2.0 | 2 | 5 | 93 |
| 1-20 | Sn | 51.62 | | | | | |
| | In | 4.45 | | | | | |
| | Zn | 4.45 | | | | | |
| Example | Co | 28.48 | 11 | 2.0 | 2 | 5 | 94 |
| 1-21 | Sn | 51.62 | | | | | |
| | Ag | 4.45 | | | | | |
| | Zn | 4.45 | | | | | |

TABLE 1-5

| | Composition | | | | | | Capac- |
|---|---|---|---|---|---|---|---|
| | Component | | | | | | ity |
| | element other | | | Specific | Me- | Half | reten- |
| | than C | | Ratio | surface | dian | value | tion |
| | | Ratio | of C | area | size | width | ratio |
| | Kind | (wt %) | (wt %) | (m²/g) | (μm) | (°) | (%) |
| Comparative | Co | 40 | 0 | 2.0 | 2 | 5 | 15 |
| example 1-1 | Sn | 60 | | | | | |
| Comparative | Zn | 42 | 0 | 2.0 | 2 | 5 | 20 |
| example 1-2 | Sn | 58 | | | | | |
| Comparative | Fe | 32 | 0 | 2.0 | 2 | 5 | 23 |
| example 1-3 | Sn | 68 | | | | | |
| Comparative | Cu | 45 | 0 | 2.0 | 2 | 5 | 25 |
| example 1-4 | Sn | 55 | | | | | |
| Comparative | Ni | 32 | 0 | 2.0 | 2 | 5 | 18 |
| example 1-5 | Sn | 68 | | | | | |
| Comparative | Mn | 30 | 0 | 2.0 | 2 | 5 | 20 |
| example 1-6 | Sn | 70 | | | | | |
| Comparative | Ag | 42 | 0 | 2.0 | 2 | 5 | 25 |
| example 1-7 | Sn | 58 | | | | | |

TABLE 1-6

| | | | | | Crystal | | | | | |
|---|---|---|---|---|---|---|---|---|---|---|
| | Composition | | | | particle | | | | | |
| | Component | | | | diameter | | | | XPS | |
| | element other | | | Specific | of | | Half | XPS | Sn—C | Capacity |
| | than C | | | surface | reaction | Median | value | C1 s | peak | retention |
| | | Ratio | Ratio of C | area | phase | size | width | peak | difference | ratio |
| | Kind | (wt %) | (wt %) | (m²/g) | (nm) | (μm) | (°) | (eV) | (eV) | (%) |
| Example 1-22 | Cu | 36 | 10 | 1.5 | — | 1 | 5.2 | 283.8 | 201.1 | 90 |
| | Sn | 54 | | | | | | | | |
| Example 1-23 | Fe | 36 | 10 | 1.4 | — | 1 | 6.2 | 283.8 | 201.1 | 89 |
| | Sn | 54 | | | | | | | | |
| Example 1-24 | Co | 35 | 11 | 2.1 | — | 1 | 6.2 | 283.8 | 201.1 | 92 |
| | Sn | 54 | | | | | | | | |
| Example 1-25 | Zn | 36 | 10 | 1.6 | — | 1 | 5.3 | 283.8 | 201.1 | 88 |
| | Sn | 54 | | | | | | | | |
| Example 1-26 | Ni | 36 | 10 | 1.5 | — | 1 | 4.2 | 283.8 | 201.1 | 85 |
| | Sn | 54 | | | | | | | | |
| Example 1-27 | Mn | 36 | 10 | 1.8 | — | 1 | 4.9 | 283.8 | 201.1 | 87 |
| | Sn | 54 | | | | | | | | |
| Example 1-28 | In | 36 | 10 | 1.8 | — | 1 | 5.6 | 283.8 | 201.1 | 86 |
| | Sn | 54 | | | | | | | | |
| Example 1-29 | Ag | 36 | 10 | 1.6 | — | 1 | 5.5 | 283.8 | 201.1 | 88 |
| | Sn | 54 | | | | | | | | |

TABLE 1-7

| | | | | | Crystal | | | | | |
|---|---|---|---|---|---|---|---|---|---|---|
| | Composition | | | | particle | | | | | |
| | Component | | | | diameter | | | | XPS | |
| | element other | | | Specific | of | | Half | XPS | Sn—C | Capacity |
| | than C | | | surface | reaction | Median | value | C1 s | peak | retention |
| | | Ratio | Ratio of C | area | phase | size | width | peak | difference | ratio |
| | Kind | (wt %) | (wt %) | (m²/g) | (nm) | (μm) | (°) | (eV) | (eV) | (%) |
| Example 1-30 | Ni | 36 | 10 | 1.7 | — | 1 | 5.8 | 283.8 | 201.1 | 92 |
| | Sn | 50 | | | | | | | | |
| | Zn | 4 | | | | | | | | |
| Example 1-31 | Cu | 36 | 10 | 1.9 | — | 1 | 6.5 | 283.8 | 201.1 | 93 |
| | Sn | 50 | | | | | | | | |
| | Ag | 4 | | | | | | | | |
| Example 1-32 | Co | 36 | 10 | 2.1 | — | 1 | 7.8 | 283.8 | 201.1 | 94 |
| | Sn | 50 | | | | | | | | |
| | In | 4 | | | | | | | | |
| Example 1-33 | Fe | 36 | 10 | 2.3 | — | 1 | 6.6 | 283.8 | 201.1 | 93 |
| | Sn | 50 | | | | | | | | |
| | Ag | 4 | | | | | | | | |
| Example 1-34 | Mn | 36 | 10 | 2.4 | — | 1 | 7.0 | 283.8 | 201.1 | 90 |
| | Sn | 50 | | | | | | | | |
| | Zn | 4 | | | | | | | | |
| Example 1-35 | Fe | 36 | 10 | 2.8 | — | 1 | 6.8 | 283.8 | 201.1 | 91 |
| | Sn | 50 | | | | | | | | |
| | In | 4 | | | | | | | | |
| Example 1-36 | Co | 40 | 10 | 2.1 | — | 1 | 5.8 | 283.7 | — | 81 |
| | Ge | 40 | | | | | | | | |
| | In | 10 | | | | | | | | |
| Example 1-37 | Cu | 50 | 10 | 2.4 | — | 1 | 6.1 | 283.7 | — | 84 |
| | Ge | 30 | | | | | | | | |
| | In | 10 | | | | | | | | |
| Example 1-38 | Cu | 40 | 20 | 3.1 | — | 1 | 6.6 | 283.7 | — | 82 |
| | Si | 20 | | | | | | | | |
| | In | 20 | | | | | | | | |
| Example 1-39 | Cu | 50 | 20 | 2.8 | — | 1 | 7.2 | 283.7 | — | 81 |
| | Si | 20 | | | | | | | | |
| | In | 10 | | | | | | | | |
| Example 1-40 | Co | 24 | 20 | 2.2 | — | 1 | 9.5 | 283.8 | 201.1 | 91 |
| | Sn | 47 | | | | | | | | |
| | In | 5 | | | | | | | | |
| | Ti | 4 | | | | | | | | |
| Example 1-41 | Co | 24 | 20 | 2.2 | — | 1 | 9.2 | 283.8 | 201.1 | 93 |
| | Sn | 47 | | | | | | | | |
| | In | 5 | | | | | | | | |
| | Hf | 4 | | | | | | | | |
| Example 1-42 | Co | 24 | 20 | 2.2 | — | 1 | 9.1 | 283.8 | 201.1 | 92 |
| | Sn | 47 | | | | | | | | |
| | In | 5 | | | | | | | | |
| | Hf | 4 | | | | | | | | |

TABLE 1-8

| | | | | | Crystal | | | | | |
|---|---|---|---|---|---|---|---|---|---|---|
| | Composition | | | | particle | | | | | |
| | Component | | | | diameter | | | | XPS | |
| | element other | | | Specific | of | | Half | XPS | Sn—C | Capacity |
| | than C | | | surface | reaction | Median | value | C1 s | peak | retention |
| | | Ratio | Ratio of C | area | phase | size | width | peak | difference | ratio |
| | Kind | (wt %) | (wt %) | (m²/g) | (nm) | (μm) | (°) | (eV) | (eV) | (%) |
| Comparative | Cu | 40 | 0 | 1.2 | 20 | 1 | 2.1 | — | — | 51 |
| example 1-8 | Sn | 60 | | | | | | | | |
| Comparative | Fe | 40 | 0 | 1.3 | 25 | 1 | 1.9 | — | — | 53 |
| example 1-9 | Sn | 60 | | | | | | | | |
| Comparative | Co | 40 | 0 | 1.5 | 20 | 1 | 2.1 | — | — | 61 |
| example 1-10 | Sn | 60 | | | | | | | | |
| Comparative | Zn | 40 | 0 | 1.1 | 20 | 1 | 2.4 | — | — | 50 |
| example 1-11 | Sn | 60 | | | | | | | | |
| Comparative | Ni | 40 | 0 | 1.2 | 30 | 1 | 2.2 | — | — | 51 |
| example 1-12 | Sn | 60 | | | | | | | | |
| Comparative | Mn | 40 | 0 | 0.9 | 19 | 1 | 2.3 | — | — | 52 |
| example 1-13 | Sn | 60 | | | | | | | | |
| Comparative | In | 40 | 0 | 0.5 | 21 | 1 | 2.3 | — | — | 53 |
| example 1-14 | Sn | 60 | | | | | | | | |
| Comparative | Ag | 40 | 0 | 0.7 | 0.1 | 1 | 2.2 | — | — | 55 |
| example 1-15 | Sn | 60 | | | | | | | | |

TABLE 2

| | Composition | | | | | | |
|---|---|---|---|---|---|---|---|
| | Component | | | | | | |
| | element | | | Specific | | | Capacity |
| | other than C | | Ratio | surface | Median | Half value | retention |
| | | Ratio | of C | area | size | width | ratio |
| | Kind | (wt %) | (wt %) | (m²/g) | (μm) | (°) | (%) |
| Example 1-1 | Co | 39.8 | 0.5 | 2.0 | 2 | 5 | 72 |
| | Sn | 59.7 | | | | | |
| Example 2-1 | Co | 39.8 | 0.5 | 2.0 | 2 | 10 | 75 |
| | Sn | 59.7 | | | | | |
| Example 2-2 | Co | 34 | 15 | 10 | 0.1 | 25 | 95 |
| | Sn | 51 | | | | | |
| Example 2-3 | Co | 34 | 15 | 60 | 0.1 | Unmeasurable | 98 |
| | Sn | 51 | | | | | |
| Comparative | Co | 39.8 | 0.5 | 2.0 | 2 | 0.3 | 40 |
| example 2-1 | Sn | 59.7 | | | | | |

TABLE 3

| | Composition | | | | | | Capac- |
|---|---|---|---|---|---|---|---|
| | Component | | | | | | ity |
| | element other | | | Specific | Me- | Half | reten- |
| | than C | | Ratio | surface | dian | value | tion |
| | | Ratio | of C | area | size | width | ratio |
| | Kind | (wt %) | (wt %) | (m²/g) | (μm) | (°) | (%) |
| Example 1-1 | Co | 39.8 | 0.5 | 2.0 | 2 | 5 | 72 |
| | Sn | 59.7 | | | | | |
| Example 3-1 | Co | 32 | 20 | 70 | 0.1 | 10 | 71 |
| | Sn | 48 | | | | | |
| Comparative | Co | 39.7 | 0.6 | 0.01 | 0.1 | 10 | 44 |
| example 3-1 | Sn | 59.7 | | | | | |
| Comparative | Co | 32 | 20 | 80 | 0.1 | 10 | 51 |
| example 3-2 | Sn | 48 | | | | | |

TABLE 4-1

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 4-1 | Co | 36 | 10 | 2.3 | — | 1 | 5.6 | 284.4 | 200.5 | 82 |
| | Sn | 54 | | | | | | | | |
| Example 4-2 | Co | 36 | 10 | 2.4 | — | 1 | 5.7 | 284.0 | 200.9 | 91 |
| | Sn | 54 | | | | | | | | |
| Example 4-3 | Co | 36 | 10 | 2.4 | — | 1 | 6.4 | 283.0 | 201.9 | 90 |
| | Sn | 54 | | | | | | | | |
| Example 4-4 | Co | 36 | 10 | 2.4 | — | 1 | 7.0 | 282.5 | 202.4 | 85 |
| | Sn | 54 | | | | | | | | |
| Comparative | Co | 40 | 0 | 1.5 | 20 | 1 | 2.1 | — | — | 61 |
| example 1-10 | Sn | 60 | | | | | | | | |

TABLE 4-2

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Comparative | Fe | 40 | 0 | 1.3 | 25 | 1 | 1.9 | — | — | 53 |
| example 1-9 | Sn | 60 | | | | | | | | |
| Comparative | Fe | 39 | 3 | 0.8 | 500 | 20 | 0.02 | 284.8 | 200.1 | 54 |
| example 4-1 | Sn | 58 | | | | | | | | |

TABLE 5-1

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 5-1 | Fe | 34 | 12 | 1.1 | 15000 | 20 | 0.05 | 283.8 | 201.1 | 51 |
| | Sn | 54 | | | | | | | | |
| Example 5-2 | Fe | 34 | 12 | 1.3 | 7000 | 10 | 0.02 | 283.8 | 201.1 | 68 |
| | Sn | 54 | | | | | | | | |
| Example 5-3 | Fe | 34 | 12 | 1.4 | 500 | 10 | 0.5 | 283.8 | 201.1 | 74 |
| | Sn | 54 | | | | | | | | |
| Example 1-23 | Fe | 36 | 10 | 1.4 | — | 1 | 6.2 | 283.8 | 201.1 | 89 |
| | Sn | 54 | | | | | | | | |
| Example 5-4 | Fe | 34 | 12 | 1.5 | 50 | 1 | 1.4 | 283.8 | 201.1 | 80 |
| | Sn | 54 | | | | | | | | |
| Example 55 | Fe | 34 | 12 | 2.1 | 5 | 1 | 0.4 | 283.8 | 201.1 | 83 |
| | Sn | 54 | | | | | | | | |

TABLE 5-2

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 5-6 | Co | 29 | 12 | 1.1 | 15000 | 20 | 0.04 | 284.3 | 201.1 | 53 |
| | Sn | 53 | | | | | | | | |
| | In | 6 | | | | | | | | |
| Example 5-7 | Co | 29 | 12 | 1.4 | 7000 | 10 | 0.02 | 284.0 | 201.1 | 71 |
| | Sn | 53 | | | | | | | | |
| | In | 6 | | | | | | | | |
| Example 5-8 | Co | 29 | 12 | 1.6 | 500 | 1 | 0.4 | 284.0 | 201.1 | 75 |
| | Sn | 53 | | | | | | | | |
| | In | 6 | | | | | | | | |
| Example 5-9 | Co | 29 | 12 | 1.7 | 50 | 1 | 1.4 | 284.1 | 201.1 | 80 |
| | Sn | 53 | | | | | | | | |
| | In | 6 | | | | | | | | |
| Example 5-10 | Co | 29 | 12 | 2.0 | 5 | 1 | 4.1 | 284.0 | 201.1 | 85 |
| | Sn | 53 | | | | | | | | |
| | In | 6 | | | | | | | | |

TABLE 6-1

| | Composition | | | | | | |
|---|---|---|---|---|---|---|---|
| | Component | | | | | | |
| | element | | | Specific | | | Capacity |
| | other than C | | Ratio | surface | Median | Half value | retention |
| | | Ratio | of C | area | size | width | ratio |
| | Kind | (wt %) | (wt %) | (m²/g) | (μm) | (°) | (%) |
| Example 1-1 | Co | 39.8 | 0.5 | 2.0 | 2 | 5 | 72 |
| | Sn | 59.7 | | | | | |
| Example 6-1 | Co | 39.2 | 2 | 2.0 | 2 | 5 | 81 |
| | Sn | 58.8 | | | | | |
| Example 6-2 | Co | 38 | 5 | 2.0 | 2 | 5 | 92 |
| | Sn | 57 | | | | | |
| Example 6-3 | Co | 30 | 25 | 2.0 | 2 | 5 | 91 |
| | Sn | 45 | | | | | |
| Example 6-4 | Co | 24 | 40 | 2.0 | 2 | 5 | 85 |
| | Sn | 36 | | | | | |
| Example 6-5 | Co | 39.8 | 0.5 | 3.0 | 2 | 5 | 78 |
| | Sn | 59.7 | | | | | |
| Example 6-6 | Co | 20 | 50 | 2.0 | 2 | 5 | 75 |
| | Sn | 30 | | | | | |
| Comparative | Co | 40 | 0 | 2.0 | 2 | 5 | 15 |
| example 1-1 | Sn | 60 | | | | | |

TABLE 6-2

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 6-7 | Fe | 38.5 | 1.5 | 1.1 | 25 | 1 | 1.9 | 283.8 | 201.1 | 65 |
| | Sn | 60 | | | | | | | | |
| Example 6-8 | Fe | 37.0 | 3 | 1.3 | 6 | 1 | 4.6 | 283.8 | 201.1 | 78 |
| | Sn | 60 | | | | | | | | |
| Example 6-9 | Fe | 31.0 | 8 | 1.5 | — | 1 | 5.4 | 283.8 | 201.1 | 85 |
| | Sn | 61 | | | | | | | | |
| Example 1-23 | Fe | 36 | 10 | 1.4 | — | 1 | 6.2 | 283.8 | 201.1 | 89 |
| | Sn | 54 | | | | | | | | |
| Example 6-10 | Fe | 30 | 25 | 3.1 | — | 1 | 8.7 | 283.8 | 201.1 | 88 |
| | Sn | 45 | | | | | | | | |
| Example 6-11 | Fe | 22 | 45 | 4.5 | — | 1 | 9.5 | 283.8 | 201.1 | 84 |
| | Sn | 33 | | | | | | | | |
| Example 6-12 | Fe | 18 | 55 | 5.6 | — | 1 | 9.9 | 283.8 | 201.1 | 75 |
| | Sn | 27 | | | | | | | | |
| Comparative | Fe | 40 | 0 | 1.3 | 25 | 1 | 1.9 | — | — | 53 |
| example 1-9 | Sn | 60 | | | | | | | | |

TABLE 6-3

| | Composition | | | | Crystal | | | | | |
|---|---|---|---|---|---|---|---|---|---|---|
| | Component | | | | particle | | | | XPS | |
| | element | | | Specific | diameter of | Half | | XPS | Sn—C | Capacity |
| | other than C | | Ratio | surface | reaction | value | Median | C1 s | peak | retention |
| | | Ratio | of C | area | phase | width | size | peak | difference | ratio |
| | Kind | (wt %) | (wt %) | (m²/g) | (nm) | (°) | (μm) | (eV) | (eV) | (%) |
| Example 6-13 | Co | 33 | 5 | 1.6 | — | 5.1 | 1 | 283.8 | 201.1 | 85 |
| | Sn | 56 | | | | | | | | |
| | In | 6 | | | | | | | | |
| Example 1-32 | Co | 36 | 10 | 2.1 | — | 1 | 7.8 | 283.8 | 201.1 | 94 |
| | Sn | 50 | | | | | | | | |
| | In | 4 | | | | | | | | |
| Example 6-14 | Co | 30 | 11 | 2.4 | — | 8.0 | 1 | 283.8 | 201.1 | 94 |
| | Sn | 53 | | | | | | | | |
| | In | 6 | | | | | | | | |
| Example 6-15 | Co | 28 | 20 | 3.0 | — | 9.5 | 1 | 283.8 | 201.1 | 94 |
| | Sn | 47 | | | | | | | | |
| | In | 5 | | | | | | | | |
| Example 6-16 | Co | 20 | 40 | 4.2 | — | 10.3 | 1 | 283.8 | 201.1 | 92 |
| | Sn | 36 | | | | | | | | |
| | In | 4 | | | | | | | | |
| Example 6-17 | Co | 14 | 55 | 5.4 | — | 11.4 | 1 | 283.8 | 201.1 | 73 |
| | Sn | 28 | | | | | | | | |
| | In | 3 | | | | | | | | |

TABLE 7-1

| | Composition | | | | | | |
|---|---|---|---|---|---|---|---|
| | Component | | | | | | |
| | element | | | Specific | | | Capacity |
| | other than C | | Ratio | surface | Median | Half value | retention |
| | | Ratio | of C | area | size | width | ratio |
| | Kind | (wt %) | (wt %) | (m²/g) | (μm) | (°) | (%) |
| Example 7-1 | Co | 36 | 10 | 4.2 | 0.05 | 10 | 71 |
| | Sn | 54 | | | | | |
| Example 7-2 | Co | 36 | 10 | 4.2 | 0.1 | 8 | 86 |
| | Sn | 54 | | | | | |
| Example 7-3 | Co | 36 | 10 | 3.6 | 5 | 5 | 87 |
| | Sn | 54 | | | | | |
| Example 7-4 | Co | 36 | 10 | 2.5 | 20 | 5 | 82 |
| | Sn | 54 | | | | | |
| Example 7-5 | Co | 36 | 10 | 2.0 | 30 | 5 | 73 |
| | Sn | 54 | | | | | |

TABLE 7-2

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 1-23 | Fe | 36 | 10 | 1.4 | — | 1 | 6.2 | 283.8 | 201.1 | 89 |
| | Sn | 54 | | | | | | | | |
| Example 7-6 | Fe | 36 | 10 | 1.1 | — | 20 | 6.2 | 283.8 | 201.1 | 82 |
| | Sn | 54 | | | | | | | | |
| Example 7-7 | Fe | 36 | 10 | 1.3 | — | 45 | 6.2 | 283.8 | 201.1 | 79 |
| | Sn | 54 | | | | | | | | |
| Example 7-8 | Fe | 36 | 10 | 1.3 | — | 60 | 6.2 | 283.8 | 201.1 | 70 |
| | Sn | 54 | | | | | | | | |

TABLE 7-3

| | Composition | | | | Crystal | | | | | |
|---|---|---|---|---|---|---|---|---|---|---|
| | Component | | | | particle | | | | XPS | |
| | element other | | | Specific | diameter of | | Half | XPS | Sn—C | Capacity |
| | than C | | Ratio | surface | reaction | Median | value | C1 s | peak | retention |
| | | Ratio | of C | area | phase | size | width | peak | difference | ratio |
| | Kind | (wt %) | (wt %) | (m²/g) | (nm) | (μm) | (°) | (eV) | (eV) | (%) |
| Example 1-32 | Co | 36 | 10 | 2.1 | — | 1 | 7.8 | 283.8 | 201.1 | 94 |
| | Sn | 50 | | | | | | | | |
| | In | 4 | | | | | | | | |
| Example 7-9 | Co | 30 | 11 | 1.1 | — | 20 | 6.2 | 283.8 | 201.1 | 81 |
| | Sn | 53 | | | | | | | | |
| | In | 6 | | | | | | | | |
| Example 7-10 | Co | 30 | 11 | 1.3 | — | 45 | 6.2 | 283.8 | 201.1 | 79 |
| | Sn | 53 | | | | | | | | |
| | In | 6 | | | | | | | | |
| Example 7-11 | Co | 30 | 11 | 1.3 | — | 60 | 6.2 | 283.8 | 201.1 | 69 |
| | Sn | 53 | | | | | | | | |
| | In | 6 | | | | | | | | |

TABLE 8-1

| | Composition | | | | | | Ca- |
|---|---|---|---|---|---|---|---|
| | Component | | | | | | pacity |
| | element other | | Ratio | Specific | | Half | reten- |
| | than C | | of C | surface | Median | value | tion |
| | | Ratio | (wt | area | size | width | ratio |
| | Kind | (wt %) | %) | (m²/g) | (μm) | (°) | (%) |
| Example 8-1 | Fe | 28.8 | 10 | 2.0 | 2 | 5 | 81 |
| | Sn | 61.2 | | | | | |
| Example 8-2 | Co | 36 | 10 | 2.0 | 2 | 5 | 81 |
| | Sn | 54 | | | | | |
| Comparative | Fe | 32 | 0 | 2.0 | 2 | 5 | 21 |
| example 8-1 | Sn | 68 | | | | | |
| Comparative | Co | 40 | 0 | 2.0 | 2 | 5 | 18 |
| example 8-2 | Sn | 60 | | | | | |

TABLE 8-2

| | Composition | | | | Crystal | | | | | |
|---|---|---|---|---|---|---|---|---|---|---|
| | Component | | | | particle | | | | XPS | |
| | element other | | | Specific | diameter | Half | | XPS | Sn—C | Capacity |
| | than C | | Ratio | surface | of reaction | value | Median | C1 s | peak | retention |
| | | Ratio | of C | area | phase | width | size | peak | difference | ratio |
| | Kind | (wt %) | (wt %) | (m²/g) | (nm) | (°) | (μm) | (eV) | (eV) | (%) |
| Example 8-3 | Cu | 36 | 10 | 1.8 | — | 4.8 | 1 | 283.8 | 201.1 | 83 |
| | Sn | 54 | | | | | | | | |
| Example 8-4 | Fe | 36 | 10 | 1.7 | — | 4.7 | 1 | 283.8 | 201.1 | 82 |
| | Sn | 54 | | | | | | | | |
| Comparative | Cu | 40 | 0 | 0.8 | 50 | 1.5 | 1 | — | — | 40 |
| example 8-3 | Sn | 60 | | | | | | | | |
| Comparative | Fe | 40 | 0 | 0.7 | 56 | 1.3 | 1 | — | — | 40 |
| example 8-4 | Sn | 60 | | | | | | | | |

TABLE 8-3

| | Composition | | | | Crystal | | | | | |
|---|---|---|---|---|---|---|---|---|---|---|
| | Component | | | | particle | | | | XPS | |
| | element other | | | Specific | diameter | Half | | XPS | Sn—C | Capacity |
| | than C | | Ratio | surface | of reaction | value | Median | C1 s | peak | retention |
| | | Ratio | of C | area | phase | width | size | peak | difference | ratio |
| | Kind | (wt %) | (wt %) | (m²/g) | (nm) | (°) | (μm) | (eV) | (eV) | (%) |
| Example 8-5 | Co | 33 | 5 | 1.11 | 1500 | 0.06 | 20 | 283.8 | 201.1 | 72 |
| | Sn | 56 | | | | | | | | |
| | In | 6 | | | | | | | | |
| Example 8-6 | Co | 30 | 11 | 1.1 | 1500 | 0.07 | 20 | 283.8 | 201.1 | 77 |
| | Sn | 53 | | | | | | | | |
| | In | 6 | | | | | | | | |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-40. (canceled)

41: An anode material having a reaction phase containing:
an element capable of generating an intermetallic compound with lithium; and
carbon, wherein
a peak of carbon is obtained in a region lower than about 284.5 eV by X-ray photoelectron spectroscopy.

42: An anode material according to claim 41, wherein a half value width of a diffraction peak obtained by X-ray diffraction of the reaction phase is about 0.5° or more.

43: An anode material according to claim 41, wherein the reaction phase contains tin and at least one constituent selected from the group consisting of nickel, copper, iron (Fe), cobalt, manganese, zinc, indium, and silver.

44: An anode material according to claim 43, wherein the reaction phase contains tin; at least one selected from the group consisting of zinc, indium, and silver; and at least one selected from the group consisting of nickel, copper, iron, cobalt, and manganese.

45: An anode material according to claim 41, wherein the reaction phase further contains at least one selected from the group consisting of elements from Group 4 to Group 6 in a long period periodic table.

46: An anode material according to claim 41, wherein a ratio of carbon ranges from about 2% by weight to about 50% by weight.

47: An anode material according to claim 41, wherein a specific surface area ranges from about 0.05 m²/g to about 70 m²/g.

48: An anode material according to claim 41, wherein a median size is about 50 μm or less.

49: An anode material according to claim 41, wherein an average crystal particle diameter of the reaction phase is about 10 μm or less.

50: An anode material having a reaction phase containing:
tin; and
carbon, wherein
an energy difference between a peak of 3d_{5/2} orbit of tin atom and a peak of 1s orbit of carbon atom obtained by X-ray photoelectron spectroscopy is larger than about 200.1 eV.

51: An anode material according to claim 50, wherein a half value width of a diffraction peak obtained by X-ray diffraction of the reaction phase is about 0.5° or more.

52: An anode material according to claim 50, wherein the reaction phase further contains at least one selected from the group consisting of nickel, copper, iron, cobalt, manganese, zinc, indium and silver.

53: An anode material according to claim 52, wherein the reaction phase contains at least one selected from the group consisting of zinc, indium, and silver; and at least one selected from the group consisting of nickel, copper, iron, cobalt, and manganese.

54: An anode material according to claim 50, wherein the reaction phase further contains at least one selected from the group consisting of elements from Group 4 to Group 6 in a long period periodic table.

55: An anode material according to claim 50, wherein a ratio of carbon ranges from about 2% by weight to about 50% by weight.

56: An anode material according to claim 50, wherein a specific surface area ranges from about 0.05 m²/g to about 70 m²/g.

57: An anode material according to claim 50, wherein a median size is about 50 μm or less.

58: An anode material according to claim 50, wherein an average crystal particle diameter of the reaction phase is about 10 μm or less.

59: A method of manufacturing an anode material having a reaction phase containing an element capable of generating an intermetallic compound with lithium and carbon, the method comprising synthesizing the anode material by mechanical alloying using a raw material containing an element capable of generating an intermetallic compound with lithium and a raw material for carbon.

60: A method of manufacturing an anode material according to claim 59, wherein as a raw material containing an element capable of generating an intermetallic compound with lithium, an alloy containing at least two or more elements other than carbon is used.

61: A method of manufacturing an anode material according to claim 59, wherein as a raw material for carbon, at least one selected from the group consisting of non-graphitizable carbon, graphitizable carbon, graphite, pyrolytic carbons, coke, glassy carbons, organic high molecular weight compound fired body, activated carbon, and carbon black is used.

62: A method of manufacturing an anode material according to claim 59, wherein as a raw material for carbon, at least one selected from the group consisting of fiber type, spherical type, granular type, and scale type carbonaceous materials is used.

63: A battery comprising:
a cathode;
an anode; and
an electrolyte, wherein
the anode contains an anode material having a reaction phase containing an element capable of generating an intermetallic compound with lithium and carbon, and wherein
the anode material provides a peak of carbon in a region lower than about 284.5 eV by X-ray photoelectron spectroscopy.

64: A battery according to claim 63, wherein a half value width of a diffraction peak obtained by X-ray diffraction of the reaction phase is about 0.5° or more.

65: A battery according to claim 63, wherein the reaction phase contains tin and at least one selected from the group consisting of nickel, copper, iron, cobalt, manganese, zinc, indium and silver.

66: A battery according to claim 65, wherein the reaction phase contains tin; at least one selected from the group consisting of zinc, indium, and silver; and at least one selected from the group consisting of nickel, copper, iron, cobalt, and manganese.

67: A battery according to claim 63, wherein the reaction phase further contains at least one selected from the group consisting of elements from Group 4 to Group 6 in a long period periodic table.

68: A battery according to claim 63, wherein in the anode material, a ratio of carbon ranges from about 2% by weight to about 50% by weight.

69: A battery according to claim 63, wherein a specific surface area of the anode material ranges from about 0.05 m²/g to about 70 m²/g.

70: A battery according to claim 63, wherein a median size of the anode material is about 50 μm or less.

71: A battery according to claim 63, wherein an average crystal particle diameter of the reaction phase is about 10 μm or less.

72: A battery comprising:
a cathode;
an anode; and
an electrolyte, wherein
the anode contains an anode material having a reaction phase containing tin and carbon, and wherein
in the anode material, an energy difference between a peak of 3d_{5/2} orbit of tin atom and a peak of is orbit of carbon atom, which are obtained by X-ray photoelectron spectroscopy is larger than about 200.1 eV.

73: A battery according to claim 72, wherein a half value width of a diffraction peak obtained by X-ray diffraction of the reaction phase is about 0.5° or more.

74: A battery according to claim 72, wherein the reaction phase further contains at least one selected from the group consisting of nickel, copper, iron, cobalt, manganese, zinc, indium and silver.

75: A battery according to claim 74, wherein the reaction phase contains at least one selected from the group consisting of zinc, indium, and silver; and at least one selected from the group consisting of nickel, copper, iron, cobalt, and manganese.

76: A battery according to claim 72, wherein the reaction phase further contains at least one selected from the group consisting of elements from Group 4 to Group 6 in a long period periodic table.

77: A battery according to claim 72, wherein in the anode material, a ratio of carbon ranges from about 2% by weight to about 50% by weight.

78: A battery according to claim 72, wherein a specific surface area of the anode material ranges from about 0.05 m²/g to about 70 m²/g.

79: A battery according to claim 72, wherein a median size of the anode material is about 50 μm or less.

80: A battery according to claim 72, wherein an average crystal particle diameter of the reaction phase is about 10 μm or less.
